(19) United States
(12) Patent Application Publication
(10) Pub. No.: US 2025/0297088 A1
(43) Pub. Date: Sep. 25, 2025

(54) A SUSTAINABLE SOLUTION FOR METAL PLATING OF PLASTIC ARTICLES

(71) Applicant: SABIC Global Technologies B.V., Bergen op Zoom (NL)

(72) Inventors: Amit Kumar Tevtia, Bengaluru (IN); Sara Ali Abbas, Bengaluru (IN); Mohamed Ashraf Moideen, Bengaluru (IN); Dhanabalan Anantharaman, Bengaluru (IN)

(21) Appl. No.: 18/872,956

(22) PCT Filed: Jun. 28, 2023
(86) PCT No.: PCT/EP2023/067617

§ 371 Date: Dec. 9, 2024

(30) Foreign Application Priority Data
Jun. 29, 2022 (EP) 22181843.8

(51) Int. Cl. C08L 25/12; C08J 3/20; C08J 7/14; C25D 3/38; C25D 5/56

(52) U.S. Cl. CPC C08L 25/12; C08J 3/203; C08J 7/14; C25D 3/38; C25D 5/56; C08J 2325/12; C08J 2425/14; C08J 2451/04; C08J 2483/04; C08L 2205/025; C08L 2205/035; C08L 2207/324

(57) ABSTRACT

The disclosure relates to a polymeric article, comprising a thermoplastic polymer composition, wherein the thermoplastic polymer composition includes (i) a copolymer (A) comprising polymeric units derived from a vinyl aromatic monomer, and a vinyl nitrile monomer; (ii) a rubber modified thermoplastic polymer (E), (iii) a functionalized polymer (FP), and optionally, (iv) an additive mixture. The disclosure further relates to a surface treated polymeric article comprising the polymeric article and to a method for preparing such a surface treated polymeric article. The disclosure further relates to a plated article comprising a metal layer disposed on a polymeric substrate layer comprising the surface treated polymeric article. In addition the disclosure further relates to a process of producing the plated article.

### CROSS REFERENCE TO RELATED APPLICATIONS

None.

### FIELD OF DISCLOSURE

The disclosure relates to the field of plating a metal layer on a polymeric substrate and in particular the disclosure relates to a metal plated article having a metal layer coated on to a polymeric substrate comprising a surface treated polymeric article and to a process of producing such a metal plated article. The disclosure further relates to a polymeric article, comprising a thermoplastic polymer composition such as a composition based on acrylonitrile-butadiene-styrene (ABS) polymer, which is suitable for metal plating. The disclosure further relates to a surface treated polymeric article comprising the polymeric article and to a method for preparing such a surface treated polymeric article.

### BACKGROUND

Polymeric plastic parts prepared from a thermoplastic material such as an acrylonitrile-butadiene-styrene (ABS) resin are often metalized when used for certain application such as an automotive application, where the thermoplastic material functions as a polymeric substrate on which a metal coating is deposited. For example, polymeric plastic parts prepared from an ABS polymer may be coated with a metal layer in order to impart a mirror finish look to resemble a metal part while retaining the distinct advantage of being light weighted unlike a conventional metal part. In addition, metal coatings may also improve the mechanical strength, thermal stability, and chemical resistance of the underlying polymeric substrate on which the metal is coated. In this regard, ABS polymers are particularly useful for automotive and other industrial application on account of its desirable impact property and other useful features.

Unfortunately, it has often been observed by many industry practitioners, that metal coatings do not easily bond or adhere to most polymer based substrates unless the surfaces of such polymeric substrates are first chemically treated. For example, a common treatment that is often used in a conventional metal plating process, is to chemically etch a polymeric substrate with oxidizing reagents such as chromium trioxide or a mixture of chromic/sulfuric acids or chromic/sulfuric/phosphoric acids. These strong oxidizing agents typically micro-roughen and chemically alter the surface of the polymer substrate by forming polar organic functional groups such as R—COOH, R—OH, R—SO3 and R—CH═O at the surface of the substrate. The presence of these polar groups promote adsorption of plating catalysts from aqueous solutions that allow subsequent metal deposition to occur readily during the plating process. Such a process allows the successful metal coating on the polymer substrate.

The conventional plating process allows a strong bonding between the metal layer and the polymer substrate formed from ABS. One suitable metric to measure the success of bonding between the metal layer and the polymer substrate is by measuring the peel strength, where greater the peel strength better is the adherence of the metal on the polymer substrate. Accordingly, the conventional use of hexavalent chromium trioxide for etching provides a treated polymeric substrate which has excellent adhesion to a metal layer.

However, the use of hexavalent chromium compounds such as chromium trioxide pose certain risks and challenges such as 1) health risks on account of such compounds being extremely carcinogenic, 2) the effective disposal of waste effluents derived from the etching process, which render such etching process not only environmentally hazardous but also expensive, 3) purification of the etched plastic parts to remove any residual chromium trioxide that may be present as impurities as such impurities adversely affect the metal plating process, and 4) the use of highly oxidizing acid solution may often damage the polymeric substrate itself or render it structurally weak for metal plating.

In an effort to avoid these problems, many alternative processes to chromic acid etching have been investigated in the past. For example, dry plasma etching processes was proposed as an alternative for the wet etching process. However, application of this method is only limited to flat polymeric parts. Alternatively in the past, etching reagents such as potassium permanganate have been used in an attempt to replace chromic acid. Although, the use of heated alkaline permanganate solutions has seen some limited commercial success, owing to its slower oxidizing rate compared to chromic acid, applicability of permanganate solutions has mostly been limited.

As a further alternate approach to avoid hexavalent chromium compounds during etching, has been described in the patents/patent applications such as U.S. Pat. No. 4,415,406A and EP2009142B1. Although the technical solution described in these disclosures appear promising, there is still scope to further improve upon the process of metal plating without the need of using hexavalent chromium compounds for etching.

Therefore, illustrative embodiments of the present disclosure are directed to a polymeric article having excellent impact property that may be plated with a metal layer without the need of using hexavalent chromium compounds as etchants. Some embodiments of the present disclosure are directed to a surface treated polymeric article, which can be used as a substrate for depositing a metal layer while having excellent metal-plastic adhesion and excellent impact property. Various embodiments of the present disclosure are directed to a suitable method for surface treating a polymeric article without the need of using hexavalent chromium compounds as etchants. Some embodiments of the present disclosure are directed to a metal plated polymeric article having an excellent bonding of a metal layer to a polymeric substrate.

### SUMMARY

Illustrative embodiments of the present disclosure are directed to a polymeric article comprising a thermoplastic polymer composition, wherein the thermoplastic polymer composition comprises, consists of, or consists essentially of:
a. a copolymer (A) present in an amount of ≥35.0 wt. % and ≤70.0 wt. %, preferably ≥45.0 wt. % and ≤56.0 wt. %, with regard to the total weight of the thermoplastic polymer composition, wherein the copolymer (A) comprises or consists of polymeric units derived from (i) a vinyl aromatic monomer, and (ii) a vinyl nitrile monomer;
b. a rubber modified thermoplastic polymer (E) present in an amount of ≥26.0 wt. % and ≤50.0 wt. %, preferably ≥30.0 wt. % and ≤50.0 wt. %, with regard to the total weight of the thermoplastic polymer composition;
c. a functionalized polymer (FP), present in an amount of ≥1.0 wt. % and ≤15.0 wt. %, with regard to the total weight of the thermoplastic polymer composition, wherein the functionalized polymer (FP) is any one polymer selected from styrene maleic anhydride (SMA) copolymer or maleic anhydride grafted polystyrene (MA-g-PS), preferably the functionalized polymer (FP) is styrene maleic anhydride (SMA) copolymer; and
d. an additive mixture present in an amount of ≥0.0 wt. % and ≤5.0 wt. %, with regard to the total weight of the thermoplastic polymer composition.

Preferably, the additive mixture comprises, consists, or consists essentially of magnesium oxide (MgO), silicone oil, wax and magnesium stearate. The sum of the components (a), (b), (c) and if present (d) is 100.0 wt. %.

Preferably the polymeric article, comprises a thermoplastic polymer composition, wherein the thermoplastic polymer composition comprises, consists of, or consists essentially of:
a. a copolymer (A) present in an amount of ≥45.0 wt. % and ≤56.0 wt. %, with regard to the total weight of the thermoplastic polymer composition, wherein the copolymer (A) comprises or consists of polymeric units derived from (i) a vinyl aromatic monomer, and (ii) a vinyl nitrile monomer;
b. a rubber modified thermoplastic polymer (E) present in an amount of ≥30.0 wt. % and ≤50.0 wt. %, with regard to the total weight of the thermoplastic polymer composition;
c. a functionalized polymer (FP), present in an amount of ≥1.0 wt. % and ≤15.0 wt. %, with regard to the total weight of the thermoplastic polymer composition, wherein the functionalized polymer (FP) is any one polymer selected from styrene maleic anhydride (SMA) copolymer or maleic anhydride grafted polystyrene (MA-g-PS), preferably the functionalized polymer (FP) is styrene maleic anhydride (SMA) copolymer; and
d. an additive mixture present in an amount of ≥0.0 wt. % and ≤5.0 wt. %, with regard to the total weight of the thermoplastic polymer composition.

Preferably, the additive mixture comprises, consists of, or consists essentially of magnesium oxide (MgO), silicone oil, wax and magnesium stearate. The sum of the components (a), (b), (c), and, if present (d) is 100.0 wt. %.

In some embodiments of the disclosure.
a. the copolymer (A) is present in an amount of ≥40.0 wt. % and ≤60.0 wt. %, preferably ≥45.0 wt. % and ≤56.0 wt. %, with regard to the total weight of the thermoplastic polymer composition, wherein the copolymer (A) comprises or consists of polymeric units derived from (i) a vinyl aromatic monomer, and (ii) a vinyl nitrile monomer;
b. the rubber modified thermoplastic polymer (E) is present in an amount of ≥30.0 wt. % and ≤45.0 wt. %, preferably ≥35.0 wt. % and ≤45.0 wt. %, with regard to the total weight of the thermoplastic polymer composition;
c. the functionalized polymer (FP) is present in an amount of ≥3.0 wt. % and ≤12.0 wt. %, preferably ≥6.0 wt. % and ≤12.0 wt. %, with regard to the total weight of the thermoplastic polymer composition, wherein the functionalized polymer (FP) is any one polymer selected from styrene maleic anhydride (SMA) copolymer or maleic anhydride grafted polystyrene (MA-g-PS), preferably the functionalized polymer (FP) is styrene maleic anhydride (SMA) copolymer; and
d. the additive mixture is present in an amount of ≥1.0 wt. % and ≤3.0 wt. %, with regard to the total weight of the thermoplastic polymer composition.

Preferably, the additive mixture comprises, consists of, or consists essentially of magnesium oxide (MgO), silicone oil, wax and magnesium stearate. The sum of the components (a), (b), (c) and (d) is 100.0 wt. %.

Preferably, the polymeric article comprises the thermoplastic polymer composition, wherein the thermoplastic polymer composition comprises, consists essentially of, or consists of:
a. a copolymer (A) present in an amount of ≥35.0 wt. % and ≤70.0 wt. %, preferably ≥40.0 wt. % and ≤60.0 wt. %, preferably ≥45.0 wt. % and ≤56.0 wt. %, with regard to the total weight of the thermoplastic polymer composition, wherein the copolymer (A) comprises or consists of polymeric units derived from (i) a vinyl aromatic monomer, and (ii) a vinyl nitrile monomer;
b. a rubber modified thermoplastic polymer (E) present in an amount of ≥26.0 wt. % and ≤50.0 wt. %, preferably ≥30.0 wt. % and ≤50.0 wt. %, preferably ≥30.0 wt. % and ≤45.0 wt. %, preferably ≥35.0 wt. % and ≤45.0 wt. %, with regard to the total weight of the thermoplastic polymer composition;
c. a functionalized polymer (FP), present in an amount of ≥1.0 wt. % and ≤15.0 wt. %, preferably ≥3.0 wt. % and ≤12.0 wt. %, preferably ≥6.0 wt. % and ≤12.0 wt. %, with regard to the total weight of the thermoplastic polymer composition, wherein the functionalized polymer (FP) is any one polymer selected from styrene maleic anhydride (SMA) copolymer or maleic anhydride grafted polystyrene (MA-g-PS), preferably the functionalized polymer (FP) is styrene maleic anhydride (SMA) copolymer; and
d. an additive mixture present in an amount of ≥0.0 wt. % and ≤5.0 wt. %, preferably ≥0.0 wt. % and ≤5.0 wt. %, preferably ≥1.0 wt. % and ≤5.0 wt. %, preferably ≥1.0 wt. % and ≤3.0 wt. %, with regard to the total weight of the thermoplastic polymer composition.

Preferably, the additive mixture comprises, consists of, or consists essentially of magnesium oxide (MgO), silicone oil, wax and magnesium stearate. The sum of the components (a), (b), (c) and (d) is 100.0 wt. %.

The sum of the components (a), (b), (c) and (d) is 100.0 wt. %.

It is particularly preferred that the polymeric article, comprises a thermoplastic polymer composition, wherein the thermoplastic polymer composition consists of or consists essentially of:
a. a copolymer (A) present in an amount of ≥35.0 wt. % and ≤70.0 wt. %, preferably ≥40.0 wt. % and ≤60.0 wt. %, preferably ≥45.0 wt. % and ≤56.0 wt. %, with regard to the total weight of the thermoplastic polymer composition, wherein the copolymer (A) consists of polymeric units derived from (i) a vinyl aromatic monomer, and (ii) a vinyl nitrile monomer;
b. a rubber modified thermoplastic polymer (E) present in an amount of ≥26.0 wt. % and ≤50.0 wt. %, preferably ≥30.0 wt. % and ≤50.0 wt. %, with regard to the total weight of the thermoplastic polymer composition;
c. a functionalized polymer (FP), present in an amount of ≥1.0 wt. % and ≤15.0 wt. %, preferably ≥3.0 wt. % and ≤12.0 wt. %, with regard to the total weight of the thermoplastic polymer composition, wherein the functionalized polymer (FP) is any one polymer selected from styrene maleic anhydride (SMA) copolymer or maleic anhydride grafted polystyrene (MA-g-PS), preferably the functionalized polymer (FP) is styrene maleic anhydride (SMA) copolymer; and
d. an additive mixture present in an amount of ≥0.0 wt. % and ≤5.0 wt. %, with regard to the total weight of the thermoplastic polymer composition.

The sum of the components (a), (b), (c) and (d) is 100.0 wt. %.

Preferably the vinyl aromatic monomer is styrene and the vinyl nitrile monomer is acrylonitrile. Preferably, the additive mixture comprises, consists of, or consists essentially of magnesium oxide (MgO), silicone oil, wax and magnesium stearate.

It is particularly preferred that the polymeric article, comprises a thermoplastic polymer composition, wherein the thermoplastic polymer composition consists of:
a. a copolymer (A) present in an amount of ≥35.0 wt. % and ≤70.0 wt. %, with regard to the total weight of the thermoplastic polymer composition, wherein the copolymer (A) consists of polymeric units derived from (i) a vinyl aromatic monomer, and (ii) a vinyl nitrile monomer;
b. a rubber modified thermoplastic polymer (E) present in an amount of ≥26.0 wt. % and ≤50.0 wt. %, preferably ≥30.0 wt. % and ≤50.0 wt. %, with regard to the total weight of the thermoplastic polymer composition;
c. a functionalized polymer (FP), present in an amount of ≥1.0 wt. % and ≤15.0 wt. %, preferably ≥3.0 wt. % and ≤12.0 wt. %, with regard to the total weight of the thermoplastic polymer composition, wherein the functionalized polymer (FP) is any one polymer selected from styrene maleic anhydride (SMA) copolymer or maleic anhydride grafted polystyrene (MA-g-PS), preferably the functionalized polymer (FP) is styrene maleic anhydride (SMA) copolymer; and
d. an additive mixture present in an amount of ≥0.0 wt. % and ≤5.0 wt. %, with regard to the total weight of the thermoplastic polymer composition.

The sum of the components (a), (b), (c) and (d) is 100.0 wt. %.

Preferably the vinyl aromatic monomer is styrene and the vinyl nitrile monomer is acrylonitrile. Preferably, the additive mixture comprises, consists of, or consists essentially of magnesium oxide (MgO), silicone oil, wax and magnesium stearate.

In some embodiments of the disclosure, the functionalized polymer (FP) may for example have:
a. a maleic anhydride content of ≥10.0 wt. % and ≤45.0 wt. %, preferably ≥15.0 wt. % and ≤40.0 wt. %, preferably ≥25.0 wt. % and ≤35.0 wt. %, preferably ≥30.0 wt. % and ≤35.0 wt. %, with regard to the total weight of the functionalized polymer (FP); and
b. a weight average molecular weight of ≥1,000 g/mol and ≤25,000 g/mol, preferably ≥2,000 g/mol and ≤20,000 g/mol, preferably ≥5,000 g/mol and ≤18,000 g/mol, preferably ≥10,000 g/mol and ≤18,000 g/mol, preferably ≥12,000 g/mol and ≤18,000 g/mol, when determined in accordance with ASTM D5296-11.

In some embodiments of the disclosure, (i) the vinyl aromatic monomer may for example be selected from styrene, α-methyl styrene, dibromostyrene, vinyltoluene, vinylxylene, butylstyrene, p-hydroxystyrene, and methoxystyrene, preferably the vinyl aromatic monomer is styrene; and/or (ii) the vinyl nitrile monomer is selected from acrylonitrile, alpha-chloro acrylonitrile, methacrylonitrile, and ethacrylonitrile, preferably the vinyl nitrile monomer is acrylonitrile. Preferably the vinyl aromatic monomer is styrene and the vinyl nitrile monomer is acrylonitrile.

In some embodiments of the disclosure, the rubber modified thermoplastic polymer (E), may for example comprise or consists of:
a. a polymeric rubber comprising polymeric units derived from a conjugated diene, wherein the conjugated diene is selected from 1,3-butadiene, isoprene, 1,3-heptadiene, methyl-1,3-pentadiene, 2,3-dimethyl-1,3-butadiene, 2-ethyl-1,3-pentadiene, 1,3-hexadiene, 2,4-hexadiene, and any combination thereof, preferably the conjugated diene is 1,3-butadiene; and
b. a grafting thermoplastic copolymer (C), wherein the grafting thermoplastic copolymer (C) is grafted to the polymeric rubber, and wherein the grafting thermoplastic copolymer (C) comprises polymeric units derived from:
   i. a vinyl aromatic monomer selected from styrene, α-methyl styrene, dibromostyrene, vinyltoluene, vinylxylene, butylstyrene, p-hydroxystyrene, methoxystyrene, and any combination thereof, preferably the vinyl aromatic monomer is styrene;
   ii. a vinyl nitrile monomer selected from acrylonitrile, methacrylonitrile, ethacrylonitrile, and any combinations thereof, preferably the vinyl nitrile monomer is acrylonitrile; and
   iii. optionally, a (meth)acrylic monomer selected from methyl methacrylate, ethyl methacrylate, methyl acrylate, ethyl acrylate, propyl acrylate, and propyl methacrylate, preferably the (meth)acrylic monomer is methyl methacrylate (MMA);
preferably the grafting thermoplastic copolymer (C) comprises polymeric units derived from (i) styrene, (ii) methyl methacrylate and (iii) acrylonitrile and the polymeric rubber is polybutadiene rubber comprising polymeric units derived from 1,3-butadiene.

Preferably, in some embodiments of the disclosure, the thermoplastic polymer composition comprises, consists of, or consists essentially of:
a. the copolymer (A) present in amount of ≥35.0 wt. % and ≤70.0 wt. %, preferably ≥40.0 wt. % and ≤60.0 wt. %, preferably ≥45.0 wt. % and ≤56.0 wt. %, with regard to the total weight of the thermoplastic polymer composition, wherein the copolymer (A) is styrene-acrylonitrile copolymer (SAN);
b. the rubber modified thermoplastic polymer (E), present in an amount of ≥26.0 wt. % and ≤50.0 wt. %, preferably ≥30.0 wt. % and ≤50.0 wt. %, preferably ≥30.0 wt. % and ≤45.0 wt. %, preferably ≥35.0 wt. % and ≤45.0 wt. %, with regard to the total weight of the thermoplastic polymer composition, wherein the rubber modified thermoplastic polymer (E) is polybutadiene rubber grafted with styrene/methyl methacrylate/acrylonitrile/copolymer;
c. the functionalized polymer (FP) present in an amount of ≥1.0 wt. % and ≤15.0 wt. %, preferably ≥3.0 wt. % and ≤12.0 wt. %, preferably ≥6.0 wt. % and ≤12.0 wt. %, with regard to the total weight of the thermoplastic polymer composition, wherein the functionalized polymer (FP) is styrene maleic anhydride (SMA) copolymer, wherein the styrene maleic anhydride (SMA) copolymer has:
i. a maleic anhydride content of ≥10.0 wt. % and ≤45.0 wt. %, preferably ≥15.0 wt. % and ≤40.0 wt. %, preferably ≥25.0 wt. % and ≤35.0 wt. %, with regard to the total weight of the styrene maleic anhydride (SMA) copolymer; and
ii. a weight average molecular weight of ≥1,000 g/mol and ≤25,000 g/mol, preferably ≥2,000 g/mol and ≤20,000 g/mol, preferably ≥5,000 g/mol and ≤18,000 g/mol, preferably ≥10,000 g/mol and ≤18,000 g/mol, preferably ≥12,000 g/mol and ≤18,000 g/mol, when determined in accordance with ASTM D5296-11; and
d. an additive mixture present in an amount of ≥0.0 wt. % and ≤5.0 wt. %, ≥0.0 wt. % and ≤5.0 wt. %, preferably ≥1.0 wt. % and ≤5.0 wt. %, preferably ≥1.0 wt. % and ≤3.0 wt. %, with regard to the total weight of the thermoplastic polymer composition.

Preferably wherein the additive mixture comprises, consists of, or consists essentially of magnesium oxide (MgO), silicone oil, wax and magnesium stearate. The sum of the components (a), (b), (c) and (d) is 100.0 wt. %.

In some embodiments of the disclosure, the polymeric article has:
a. a Notched Izod Impact strength of ≥15.0 kJ/m² and ≤50.0 kJ/m², preferably ≥20.0 kJ/m² and ≤40.0 kJ/m², preferably ≥20.0 kJ/m² and ≤30.0 kJ/m², when measured in accordance with ISO 180/1A; and/or
b. an average surface roughness of ≥47.0 nm and ≤200.0 nm, preferably ≥47.0 nm and ≤80.0 nm, preferably ≥47.0 nm and ≤70.0 nm when measured in accordance with as per ASTM D7127.

In some embodiments of the disclosure, the method for producing the polymeric article comprises the steps of:
a. introducing in an extruder a set of ingredients comprising the copolymer (A), the rubber modified thermoplastic polymer (E), the functionalized polymer, and optionally the additive mixture and obtaining an extrudable composition;
b. extruding the extrudable composition under conditions of extrusion and forming a set of extruded pellets; and
c. subjecting the set of extruded pellets to injection molding under conditions of:
   i. injection molding temperature of ≥210.0° C. and ≤250.0° C., preferably ≥215.0° C. and ≤240.0° C., more preferably ≥220° C. and ≤230° C.; and
   ii. injection speed of ≥10.0 mm/sec and ≤40.0 mm/sec, preferably ≥15 mm/sec and ≤35.0 mm/sec, more preferably ≥25.0 mm/sec and ≤30.0 mm/sec; and forming the polymeric article.

Some embodiments of the disclosure are directed to a surface treated polymeric article obtainable by a method comprising the steps of:
a. providing the polymeric article in accordance with one or more embodiments of the present disclosure; and
b. contacting at least a portion of the polymeric article with a chemical reagent for any time period between ≥5.0 minutes and ≤30.0 minutes, preferably ≥10.0 minutes and ≤20.0 minutes, preferably ≥15.0 minutes and ≤20.0 minutes and at a temperature condition of ≥60.0° C. and ≤80.0° C., preferably ≥65.0° C. and ≤75.0° C., and forming the surface treated polymeric article.

It is preferred that the polymeric article used for forming the surface treated polymeric article, comprises a thermoplastic polymer composition, wherein the thermoplastic polymer composition consists of or consists essentially of:
a. a copolymer (A) present in an amount of ≥35.0 wt. % and ≤70.0 wt. %, with regard to the total weight of the thermoplastic polymer composition, wherein the copolymer (A) consists of polymeric units derived from (i) a vinyl aromatic monomer, and (ii) a vinyl nitrile monomer;
b. a rubber modified thermoplastic polymer (E) present in an amount of ≥26.0 wt. % and ≤50.0 wt. %, preferably ≥30.0 wt. % and ≤50.0 wt. %, with regard to the total weight of the thermoplastic polymer composition;
c. a functionalized polymer (FP), present in an amount of ≥1.0 wt. % and ≤15.0 wt. %, preferably ≥3.0 wt. % and ≤12.0 wt. %, with regard to the total weight of the thermoplastic polymer composition, wherein the functionalized polymer (FP) is any one polymer selected from styrene maleic anhydride (SMA) copolymer or maleic anhydride grafted polystyrene (MA-g-PS), preferably the functionalized polymer (FP) is styrene maleic anhydride (SMA) copolymer; and
d. an additive mixture present in an amount of ≥0.0 wt. % and ≤5.0 wt. %, with regard to the total weight of the thermoplastic polymer composition.

The sum of the components (a), (b), (c) and (d) is 100.0 wt. %.

Preferably, the additive mixture comprises, consists of, or consists essentially of magnesium oxide (MgO), silicone oil, wax and magnesium stearate. Preferably the vinyl aromatic monomer is styrene and the vinyl nitrile monomer is acrylonitrile.

In some embodiments of the disclosure, the chemical reagent is a colloidal solution comprising manganese oxide colloidal particles suspended in a mineral acid mixture comprising sulfuric acid and phosphoric acid.

In some embodiments of the disclosure, the colloidal solution comprising manganese oxide colloidal particles suspended in a mineral acid mixture, comprises:
a. manganese oxide colloidal particles present in an amount of ≥50.0 g/L and ≤70.0 g/L, preferably ≥55.0 g/L and ≤65.0 g/L;
b. phosphoric acid present in an amount of ≥210.0 ml/L and ≤230.0 ml/L, preferably ≥215.0 ml/L and ≤225.0 ml/L; and
c. sulfuric acid present in an amount of ≥560.0 ml/L and ≤580.0 ml/L, preferably ≥570.0 ml/L and ≤575.0 ml/L;
wherein the total volume of the colloidal solution is 1.0 litre (L).

In some embodiments of the disclosure, the surface treated polymeric article has:
a. a Notched Izod Impact strength of ≥15.0 kJ/m² and ≤50.0 kJ/m², preferably ≥20.0 kJ/m² and ≤40.0 kJ/m², preferably ≥20.0 kJ/m² and ≤30.0 kJ/m², when measured in accordance with ISO 180/1A; and/or
b. wherein the surface treated polymeric article has a water contact angle of ≥60.0° and ≤85.0°, preferably ≥65.0° and ≤80.0°, preferably ≥65° and ≤750 as determined in accordance with ASTM D5946-17.

Some embodiments of the disclosure are directed to a metal plated article comprising:
a. a metal layer; and
b. a polymeric substrate layer comprising the surface treated polymeric article in accordance with one or more embodiments of the present disclosure; wherein the metal layer is disposed on at least a portion of the polymeric substrate layer, preferably the metal layer is adhered to a treated surface of the polymeric substrate layer.

In some embodiments of the disclosure, the metal layer is adhered to the treated surface of the polymeric substrate layer at a peel strength of ≥0.14 N/mm, preferably ≥0.16 N/mm, preferably ≥0.2 N/mm, preferably ≥0.3 N/mm, preferably ≥0.34 N/mm, as determined in accordance with ASTM B 533-85 (2004).

Some embodiments of the disclosure are directed to a process for producing the metal plated article, comprising the steps of:
a. providing the surface treated polymeric article in accordance with one or more embodiments of the present disclosure;
b. subjecting the surface treated polymeric article to chemical plating and forming a metal plated precursor article; and
c. contacting the metal plated precursor article with a metal electrolyte solution at any applied electric current of ≥1.0 Amps and ≤4.0 Amps, preferably ≥1.0 Amps and ≤3.0 Amps and for a time period of ≥5 minutes and ≤35 minutes, preferably ≥25 minutes and ≤35 minutes and forming the metal plated article.

Some embodiments of the disclosure are directed to the use of the surface treated polymeric article in accordance with one or more embodiments of the present disclosure for improving the adhesion of a metal layer to a polymeric substrate in a metal plated article. Some embodiments of the disclosure are directed to the use of the surface treated polymeric article in accordance with one or more embodiments of the present disclosure as a substrate suitable for receiving a metal layer.

Other objects, features and advantages of the invention will become apparent from the following detailed description, and examples. It should be understood, however, that the detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from some specific embodiments may be combined with features from any of the other embodiments. In further embodiments, additional features may be added to the specific embodiments described herein.

### DETAILED DESCRIPTION

The following includes definitions of various terms, expressions and phrases used throughout this specification.

Unless defined otherwise, all technical and scientific terms used herein have the same meaning as commonly understood by one of ordinary skill in the art to which this disclosure belongs. In this specification and in the claims which follow, reference will be made to a number of terms which shall be defined herein. All publications mentioned herein are incorporated herein by reference to disclose and describe the methods and/or materials in connection with which the publications are cited.

The use of the words “a” or “an” when used in conjunction with the term “comprising,” “including,” “containing,” or “having” in the claims or the specification may mean “one,” but it is also consistent with the meaning of “one or more,” “at least one,” and “one or more than one.” The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. The method described herein can “comprise,” “consist essentially of,” or “consist of” particular ingredients, components, compositions, etc., disclosed throughout the specification.

The expression “polymeric article” means an article or a polymer sample which is prepared by a process involving a molding process or an extrusion process, preferably by an injection molding process.

The expression “at least a portion” means at least 25.0%, preferably at least 50.0%, preferably at least 75.0%, preferably 100.0% of a parameter such as surface area.

Various embodiments of the present disclosure are based, in part, on the discovery that a polymeric article comprising a certain thermoplastic material comprising a functionalized polymer can enable the metal plating of the polymeric article without the need of using hexavalent chromium compound as etchants. For example, such a polymeric article may comprise a thermoplastic polymer composition, wherein the thermoplastic polymer composition comprises, consists of, or consists essentially of:
a. a copolymer (A) present in an amount of ≥35.0 wt. % and ≤70.0 wt. %, preferably ≥40.0 wt. % and ≤60.0 wt. %, preferably ≥45.0 wt. % and ≤56.0 wt. %, with regard to the total weight of the thermoplastic polymer composition, wherein the copolymer (A) comprises or consists of polymeric units derived from (i) a vinyl aromatic monomer, and (ii) a vinyl nitrile monomer;
b. a rubber modified thermoplastic polymer (E) present in an amount of ≥26.0 wt. % and ≤50.0 wt. %, preferably ≥30.0 wt. % and ≤50.0 wt. %, preferably ≥30.0 wt. % and ≤45.0 wt. %, preferably ≥35.0 wt. % and ≤45.0 wt. %, with regard to the total weight of the thermoplastic polymer composition;
c. a functionalized polymer (FP), present in an amount of ≥1.0 wt. % and ≤15.0 wt. %, preferably ≥3.0 wt. % and ≤12.0 wt. %, preferably ≥6.0 wt. % and ≤12.0 wt. %, with regard to the total weight of the thermoplastic polymer composition, wherein the functionalized polymer (FP) is any one polymer selected from styrene maleic anhydride (SMA) copolymer or maleic anhydride grafted polystyrene (MA-g-PS), preferably the functionalized polymer (FP) is styrene maleic anhydride (SMA) copolymer; and
d. an additive mixture present in an amount of ≥0.0 wt. % and ≤5.0 wt. %, preferably ≥0.0 wt. % and ≤5.0 wt. %, preferably ≥1.0 wt. % and ≤5.0 wt. %, preferably ≥1.0 wt. % and ≤3.0 wt. %, with regard to the total weight of the thermoplastic polymer composition.

Advantageously, the thermoplastic polymer composition constituting the polymeric article has a purposeful composition of copolymer (A), the rubber modified thermoplastic polymer (E), the functionalized polymer (FP), and optionally the additive mixture, which together enable the polymeric article to be surface treated for metal plating without the need for using hexavalent chromium compound for etching. Advantageously, the polymeric article has a suitable impact strength, thereby allowing such a polymeric article to be used for preparing metal plated articles suitable for various industrial application that require a material to have excellent impact strength.

In some embodiments of the disclosure, the polymeric article comprises the thermoplastic polymer composition present in an amount of ≥95.0 wt. %, preferably ≥97.0 wt. %, preferably ≥98.0 wt. %, preferably ≥99.0 wt. %, preferably 100.0 wt. %, with regard to the total weight of the polymeric article.

### Copolymer (A)

The copolymer (A) may for example be present in a suitable amount in the thermoplastic polymer composition. For example, the copolymer (A) may be present in an amount of ≥35.0 wt. % and ≤70.0 wt. %, preferably ≥36.0 wt. % and ≤65.0 wt. %, preferably ≥40.0 wt. % and ≤63.0 wt. %, preferably ≥40.0 wt. % and ≤60.0 wt. %, preferably ≥45.0 wt. % and ≤60.0 wt. %, preferably ≥45.0 wt. % and ≤56.0 wt. %, with regard to the total weight of the thermoplastic polymer composition, wherein the copolymer (A) comprises or consists of polymeric units derived from (i) a vinyl aromatic monomer, and (ii) a vinyl nitrile monomer. Preferably, the copolymer (A) consists of polymeric units derived from (i) a vinyl aromatic monomer, and (ii) a vinyl nitrile monomer. In other words, the copolymer (A) is derived only from the vinyl aromatic monomer and the vinyl nitrile monomer and from no other monomer.

Most preferably the copolymer (A) may for example be present in an amount of ≥45.0 wt. % and ≤60.0 wt. %, preferably ≥45.0 wt. % and ≤56.0 wt. %, with regard to the total weight of the thermoplastic polymer composition, wherein the copolymer (A) comprises polymeric units derived from (i) a vinyl aromatic monomer, and (ii) a vinyl nitrile monomer.

In some embodiments of the disclosure, the copolymer (A) has: ≥22.0 wt. % and ≤38.0 wt. %, preferably ≥25.0 wt. % and ≤35.0 wt. %, preferably ≥30.0 wt. % and ≤35.0 wt. %, of polymeric units, derived from the vinyl nitrile monomer, with regard to the total weight of the copolymer (A). Most preferably, the copolymer (A) has: ≥30.0 wt. % and ≤35.0 wt. %, of polymeric units, derived from the vinyl nitrile monomer, with regard to the total weight of the copolymer (A).

More preferably, the vinyl aromatic monomer is styrene and the vinyl nitrile monomer is acrylonitrile. Preferably, the copolymer (A) is styrene acrylonitrile copolymer. In preferred embodiments of the disclosure, the copolymer (A) is styrene acrylonitrile copolymer having ≥30.0 wt. % and ≤35.0 wt. %, of polymeric units derived from acrylonitrile. It is particularly preferred that the copolymer (A) is not a mixture of two or more different styrene acrylonitrile copolymers.

In some aspects of the disclosure, the copolymer (A) may for example be a terpolymer comprising or consisting of polymeric units derived from (i) a vinyl aromatic monomer, (ii) a vinyl nitrile monomer, and (iii) (meth)acrylic monomers. The vinyl aromatic monomer and the vinyl nitrile monomer may be selected from monomers as defined herein. The (meth)acrylic monomers may for example be selected from methyl methacrylate, ethyl methacrylate, propyl methacrylate, iso-propyl methacrylate, butyl methacrylate, hexyl methacrylate, and decyl methacrylate. Preferably, the (meth) acrylic monomer may be methyl methacrylate (MMA). Accordingly, the copolymer (A) may for example be a terpolymer comprising polymeric units derived from styrene/acrylonitrile/methylmethacrylate, or from alpha-methyl-styrene/acrylonitrile/methyl methacrylate.

The copolymer (A) may have a suitable molecular weight. For example, the copolymer (A) has an average molecular weight (Mw) of ≥50,000 g/mol and ≤100,000 g/mol, preferably ≥80,000 g/mol and ≤100,000 g/mol, preferably ≥85,000 g/mol and ≤98,000 g/mol, preferably ≥93,000 g/mol and ≤97,000 g/mol as determined in accordance with gel permeation chromatography in accordance with ASTM D5296-11. The determination of molecular weight for example was made using gel permeation chromatography in accordance with ASTM D5296-11 using polystyrene based calibration with tetrahydrofuran (TIF) as solvent.

The copolymer (A) may for example be so selected to have a suitable flow property. For example, the copolymer (A) may have a melt flow rate of ≥7.0 g/10 min and ≤20.0 g/10 min, preferably ≥8.0 g/10 min and ≤15.0 g/10 min, preferably ≥9.0 g/10 min and ≤11.0 g/10 min, as determined at 230° C. at 1.2 kg load in accordance with ISO 1133 (2005). The inventors found that if the melt flow rate of the copolymer (A) is too high, the overall impact property of the thermoplastic polymer composition may be adversely affected whereas if the melt flow rate of the copolymer (A) is too low the desired flow property of the thermoplastic polymer is not attained, affecting the processability of the thermoplastic polymer.

### Rubber Modified Thermoplastic Polymer (E):

In an aspect of the disclosure, the thermoplastic polymer composition comprises a suitable amount of a rubber component. The rubber modified thermoplastic polymer (E) may be referred to as high rubber graft or “HRG”. Preferably, the thermoplastic polymer composition comprises at least 26.0 wt. % of the rubber modified thermoplastic polymer (E). Preferably, the thermoplastic polymer composition may for example comprise the rubber modified thermoplastic polymer (E) present in an amount of ≥26.0 wt. % and ≤50.0 wt. %, preferably ≥30.0 wt. % and ≤50.0 wt. %, preferably ≥30.0 wt. % and ≤45.0 wt. %, preferably ≥35.0 wt. % and ≤45.0 wt. %, preferably ≥36.0 wt. % and ≤43.0 wt. %, with regard to the total weight of the thermoplastic polymer composition.

Most preferably, the thermoplastic polymer composition has the copolymer (A) be present in an amount of ≤60.0 wt. %, preferably ≤56.0 wt. % while the rubber modified thermoplastic polymer (E) be present in an amount of ≥26.0 wt. %, preferably ≥30.0 wt. %, with regard to the total weight of the thermoplastic polymer composition.

The rubber modified thermoplastic polymer (E) comprises or consists of (i) a polymeric rubber (ii) a grafting thermoplastic copolymer (C), wherein the grafting thermoplastic copolymer (C) is grafted to the polymeric rubber. In some embodiments of the disclosure, the polymeric rubber may be a discontinuous elastomeric phase dispersed across a continuous rigid thermoplastic phase comprising the grafting thermoplastic copolymer (C), with at least a portion of the rigid thermoplastic phase being grafted to the discontinuous elastomeric phase.

The polymeric rubber may for example have a suitable particle based morphology. For example, the polymeric rubber may be in the form of a rubber particles having a broad, monomodal particle size distribution. The polymeric rubber may for example have an average particle diameter of ≥50 nanometers (nm) and ≤1000 nanometers (nm), preferably an average particle diameter of ≥200 nanometers (nm) and ≤500 nanometers (nm).

The rubber modified thermoplastic polymer (E), comprises a suitable amount of the polymeric rubber. The rubber modified thermoplastic polymer (E) may for example have a polymeric rubber content of ≥55.0 wt. % and ≤75.0 wt. %, preferably ≥57.0 wt. % and ≤70.0 wt. %, preferably ≥60.0 wt. % and ≤65.0 wt. %, preferably ≥60.0 wt. % and ≤63.0 wt. %, with regard to the total weight of the rubber modified thermoplastic polymer (E). The polymeric rubber content may for example be determined using Fourier Transform Infrared Micro-Spectroscopy (FT-IR).

Accordingly, the rubber modified thermoplastic polymer (E) has a grafting thermoplastic copolymer (C) content of ≥25.0 wt. % and ≤45.0 wt. %, preferably ≥30.0 wt. % and ≤43.0 wt. %, preferably ≥35.0 wt. % and ≤40.0 wt. %, preferably ≥37.0 wt. % and ≤40.0 wt. %, with regard to the total weight of the rubber modified thermoplastic polymer (E). Preferably the rubber modified thermoplastic polymer (E) has a polymeric rubber content of ≥55.0 wt. % and ≤75.0 wt. %, preferably ≥57.0 wt. % and ≤70.0 wt. %, preferably ≥60.0 wt. % and ≤65.0 wt. %, preferably ≥60.0 wt. % and ≤63.0 wt. %, with regard to the total weight of the rubber modified thermoplastic polymer (E) and a grafting thermoplastic copolymer (C) content of ≥25.0 wt. % and ≤45.0 wt. %, preferably ≥30.0 wt. % and ≤43.0 wt. %, preferably ≥35.0 wt. % and ≤40.0 wt. %, preferably ≥37.0 wt. % and ≤40.0 wt. %, with regard to the total weight of the rubber modified thermoplastic polymer (E).

More preferably, the rubber modified thermoplastic polymer (E) has a polymeric rubber content of ≥60.0 wt. % and ≤65.0 wt. %, preferably ≥60.0 wt. % and ≤63.0 wt. %, with regard to the total weight of the rubber modified thermoplastic polymer (E) and a grafting thermoplastic copolymer (C) content of ≥35.0 wt. % and ≤40.0 wt. %, preferably ≥37.0 wt. % and ≤40.0 wt. %, with regard to the total weight of the rubber modified thermoplastic polymer (E).

The polymeric rubber comprises polymeric units derived from a conjugated diene, wherein the conjugated diene is selected from 1,3-butadiene, isoprene, 1,3-heptadiene, methyl-1,3-pentadiene, 2,3-dimethyl-1,3-butadiene, 2-ethyl-1,3-pentadiene, 1,3-hexadiene, 2,4-hexadiene, and any combination thereof, preferably the conjugated diene is 1,3-butadiene.

More preferably, the polymeric rubber may for example comprise polymeric units derived from a conjugated diene, for example from 1,3-butadiene to form polybutadiene.

The rubber modified thermoplastic polymer (E) may for example comprise the grafting thermoplastic copolymer (C), wherein the grafting thermoplastic copolymer (C) is grafted to the polymeric rubber, and wherein the grafting thermoplastic copolymer (C) comprises polymeric units derived from:
i. a vinyl aromatic monomer selected from styrene, α-methyl styrene, dibromostyrene, vinyltoluene, vinylxylene, butylstyrene, p-hydroxystyrene, methoxystyrene, and any combination thereof, preferably the vinyl aromatic monomer is styrene;
ii. a vinyl nitrile monomer selected from acrylonitrile, methacrylonitrile, ethacrylonitrile, and any combinations thereof, preferably the vinyl nitrile monomer is acrylonitrile; and
iii. a (meth)acrylic monomer selected from methyl methacrylate, ethyl methacrylate, and propyl methacrylate, preferably the (meth)acrylic monomer is methyl methacrylate (MMA).

Preferably, the grafting thermoplastic copolymer (C) comprises polymeric units derived from styrene, methyl methacrylate and acrylonitrile and the polymeric rubber is polybutadiene rubber comprising polymeric units derived from 1,3-butadiene.

Preferably, the rubber modified thermoplastic polymer (E) is polybutadiene rubber grafted with a copolymer comprising polymeric units derived from styrene, methyl methacrylate, acrylonitrile.

In some embodiments of the disclosure, the rubber modified thermoplastic polymer (E) may comprise a portion of the grafting thermoplastic copolymer (C) that is not chemically grafted to the polymeric rubber. The portion of the grafting thermoplastic copolymer (C) that is not chemically grafted to the polymeric rubber may be referred to as the “free thermoplastic copolymer (C)”. For example, the rubber modified thermoplastic polymer (E) may comprise ≤15.0 wt. %, preferably ≤10.0 wt. %, preferably ≤5.0 wt. %, preferably ≤2.0 wt. %, of the grafting thermoplastic copolymer (C) that is not chemically grafted to the polymeric rubber “free thermoplastic copolymer (C)”.

### Functionalized Polymer (FP)

The functionalized polymer (FP) is present in a suitable amount in the thermoplastic polymer composition. The functionalized polymer (FP) may for example be present in an amount of ≥1.0 wt. % and ≤15.0 wt. %, preferably ≥3.0 wt. % and ≤12.0 wt. %, preferably ≥6.0 wt. % and ≤12.0 wt. %, with regard to the total weight of the thermoplastic polymer composition. The functionalized polymer (FP) is any one polymer selected from styrene maleic anhydride (SMA) copolymer or maleic anhydride grafted polystyrene (MA-g-PS), preferably the functionalized polymer (FP) is styrene maleic anhydride (SMA) copolymer.

Preferably, the functionalized polymer (FP) has a maleic anhydride content of ≥10.0 wt. % and ≤45.0 wt. %, preferably ≥15.0 wt. % and ≤40.0 wt. %, preferably ≥25.0 wt. % and ≤35.0 wt. %, preferably ≥30.0 wt. % and ≤35.0 wt. %, with regard to the total weight of the functionalized polymer (FP). Preferably, the functionalized polymer (FP) has a weight average molecular weight of ≥1,000 g/mol and ≤25,000 g/mol, preferably ≥2,000 g/mol and ≤20,000 g/mol, preferably ≥5,000 g/mol and ≤18,000 g/mol, preferably ≥10,000 g/mol and ≤18,000 g/mol, preferably ≥12,000 g/mol and ≤18,000 g/mol. The determination of molecular weight for example was made using gel permeation chromatography in accordance with ASTM D5296-11 using polystyrene based calibration with tetrahydrofuran (THF) as solvent.

### Additive Mixture

The additive mixture, if present, may for example be present in the thermoplastic polymer composition in a suitable proportion. The thermoplastic polymer composition may for example comprise the additive mixture present in an amount of ≥0.0 wt. % and ≤5.0 wt. %, preferably ≥0.0 wt. % and ≤5.0 wt. %, preferably ≥1.0 wt. % and ≤5.0 wt. %, preferably ≥1.0 wt. % and ≤3.0 wt. %, preferably ≥1.0 wt. % and ≤3.0 wt. %, with regard to the total weight of the thermoplastic polymer composition. Preferably, the additive mixture comprises or consists of magnesium oxide (MgO), silicone oil, wax and magnesium stearate.

In some embodiments of the disclosure, the magnesium oxide (MgO) may for example be present in amount of ≥0.01 wt. % and ≤0.1 wt. %, preferably ≥0.01 wt. % and ≤0.05 wt. %, with regard to the total weight of the thermoplastic polymer composition. In some embodiments of the disclosure, the silicone oil may for example be present in amount of ≥0.05 wt. % and ≤0.5 wt. %, preferably ≥0.1 wt. % and ≤0.5 wt. %, with regard to the total weight of the thermoplastic polymer composition.

In some embodiments of the disclosure, the wax may for example be present in amount of ≥0.5 wt. % and ≤2.0 wt. %, preferably ≥0.8 wt. % and ≤1.5 wt. %, with regard to the total weight of the thermoplastic polymer composition. In some embodiments of the disclosure, the magnesium stearate may for example be present in an amount of ≥0.05 wt. % and ≤0.5 wt. %, preferably ≥0.1 wt. % and ≤0.4 wt. %, with regard to the total weight of the thermoplastic polymer composition.

### Polymeric Article

Preferably, the polymeric article comprises the thermoplastic polymer composition comprising, consisting of, or consisting essentially of:
a. the copolymer (A) present in amount of ≥35.0 wt. % and ≤70.0 wt. %, preferably ≥40.0 wt. % and ≤60.0 wt. %, preferably ≥45.0 wt. % and ≤56.0 wt. %, with regard to the total weight of the thermoplastic polymer composition, wherein the copolymer (A) is styrene-acrylonitrile copolymer (SAN);
b. the rubber modified thermoplastic polymer (E), present in an amount of ≥26.0 wt. % and ≤50.0 wt. %, preferably ≥30.0 wt. % and ≤50.0 wt. %, preferably ≥30.0 wt. % and ≤45.0 wt. %, preferably ≥35.0 wt. % and ≤45.0 wt. %, with regard to the total weight of the thermoplastic polymer composition, wherein the rubber modified thermoplastic polymer (E) is polybutadiene rubber grafted with styrene/methyl methacrylate/acrylonitrile/copolymer;
c. the functionalized polymer (FP) present in an amount of ≥1.0 wt. % and ≤15.0 wt. %, preferably ≥3.0 wt. % and ≤12.0 wt. %, preferably ≥6.0 wt. % and ≤12.0 wt. %, with regard to the total weight of the thermoplastic polymer composition, wherein the functionalized polymer (FP) is styrene maleic anhydride (SMA) copolymer, wherein the styrene maleic anhydride (SMA) copolymer has:
   i. a maleic anhydride content of ≥10.0 wt. % and ≤45.0 wt. %, preferably ≥15.0 wt. % and ≤40.0 wt. %, preferably ≥25.0 wt. % and ≤35.0 wt. %, with regard to the total weight of the styrene maleic anhydride (SMA) copolymer; and
   ii. a weight average molecular weight of ≥1,000 g/mol and ≤25,000 g/mol, preferably ≥2,000 g/mol and ≤20,000 g/mol, preferably ≥5,000 g/mol and ≤18,000 g/mol, preferably ≥10,000 g/mol and ≤18,000 g/mol, preferably ≥12,000 g/mol and ≤18,000 g/mol, when determined in accordance with ASTM D5296-11; and
d. an additive mixture present in an amount of ≥0.0 wt. % and ≤5.0 wt. %, ≥0.0 wt. % and ≤5.0 wt. %, preferably ≥1.0 wt. % and ≤5.0 wt. %, preferably ≥1.0 wt. % and ≤3.0 wt. %, with regard to the total weight of the thermoplastic polymer composition, wherein the additive mixture comprises, consists of, or consists essentially of magnesium oxide (MgO), silicone oil, wax and magnesium stearate.

Preferably, the polymeric article has a suitable impact property necessary for certain application including automobile components. For example, the polymeric article has a Notched Izod Impact strength of ≥15.0 kJ/m² and ≤50.0 kJ/m², preferably ≥20.0 kJ/m² and ≤40.0 kJ/m², preferably ≥20.0 kJ/m² and ≤30.0 kJ/m², when measured in accordance with ISO 180/1A.

Preferably, the polymeric article comprises the thermoplastic polymer composition, comprising, consisting of, or consisting essentially of:
a. the copolymer (A) present in amount of ≥35.0 wt. % and ≤70.0 wt. %, with regard to the total weight of the thermoplastic polymer composition, wherein the copolymer (A) is styrene-acrylonitrile copolymer (SAN);
b. the rubber modified thermoplastic polymer (E), present in an amount of ≥26.0 wt. % and ≤50.0 wt. %, wherein the rubber modified thermoplastic polymer (E) is polybutadiene rubber grafted with styrene/methyl methacrylate/acrylonitrile/copolymer;
c. the functionalized polymer (FP) present in an amount of ≥1.0 wt. % and ≤15.0 wt. %, with regard to the total weight of the thermoplastic polymer composition, wherein the functionalized polymer (FP) is styrene maleic anhydride (SMA) copolymer; and
d. an additive mixture present in an amount of ≥0.0 wt. % and ≤5.0 wt. %, with regard to the total weight of the thermoplastic polymer composition.

Preferably, the additive mixture comprises, consists of, or consisting essentially of magnesium oxide (MgO), silicone oil, wax and magnesium stearate.

Preferably, the polymeric article comprises the thermoplastic polymer composition comprising, consisting of, or consisting essentially of:
a. the copolymer (A) present in amount of ≥45.0 wt. % and ≤56.0 wt. %, with regard to the total weight of the thermoplastic polymer composition, wherein the copolymer (A) is styrene-acrylonitrile copolymer (SAN);
b. the rubber modified thermoplastic polymer (E), present in an amount of ≥35.0 wt. % and ≤45.0 wt. %, wherein the rubber modified thermoplastic polymer (E) is polybutadiene rubber grafted with styrene/methyl methacrylate/acrylonitrile/copolymer;
c. the functionalized polymer (FP) present in an amount of ≥6.0 wt. % and ≤12.0 wt. %, with regard to the total weight of the thermoplastic polymer composition, wherein the functionalized polymer (FP) is styrene maleic anhydride (SMA) copolymer; and
d. an additive mixture present in an amount of ≥1.0 wt. % and ≤3.0 wt. %, with regard to the total weight of the thermoplastic polymer composition.

### Method of Producing the Polymeric Article

Illustrative embodiments of the disclosure are directed to a method for producing the polymeric article in accordance with one or more embodiments of the present disclosure. The method for producing the polymeric article may for example involve a combination of steps involving extrusion and injection molding. Preferably, the method for producing the polymeric article comprises the steps of:
a. introducing in an extruder a set of ingredients comprising the copolymer (A), the rubber modified thermoplastic polymer (E), the functionalized polymer (FP), and optionally the additive mixture and obtaining an extrudable composition;
b. extruding the extrudable composition under conditions of extrusion and forming a set of extruded pellets; and
c. subjecting the set of extruded pellets to injection molding under conditions of:
   i. an injection molding temperature of ≥210.0° C. and ≤250.0° C., preferably ≥215.0° C. and ≤240.0° C., more preferably ≥220° C. and ≤230° C.; and
   ii. an injection speed of ≥10.0 mm/sec and ≤40.0 mm/sec, preferably ≥15 mm/sec and ≤35.0 mm/sec, more preferably ≥25.0 mm/sec and ≤30.0 mm/sec; and forming the polymeric article.

In some embodiments of the disclosure, the process of extrusion may involve physical blending of the ingredients prior to introducing the ingredients into a hopper of the extruder. For example, in some embodiments of the disclosure, prior to loading to a hopper, the pellets of the functionalized polymer (FP) and the copolymer A may be pre-mixed in a container to obtain a set of pellets mixed homogeneously and subsequently introduced into the hopper along with a pre-blend comprising the rubber modified thermoplastic polymer (E) and the additive mixture.

In some embodiments of the disclosure, the physically mixed formulations once introduced into the extruder via the hopper may be melt blended for example in a 10-barrel Coperion ZSK-26 mm co-rotating twin-screw extruder whose L/D ratio is 40:1. The condition for extrusion may for example include the extrusion to be conducted at a suitable torque, at a specific mechanical energy and at a specific RPM. For example the extrusion may be conducted at
(a) a torque of ≥30.0% and ≤75.0%, preferably ≥40.0% and ≤72.0%, more preferably ≥50.0% and ≤70.0%;
(b) a specific mechanical energy of ≥0.10 KWh/Kg and ≤0.25 KWh/Kg, preferably ≥0.12 KWh/Kg and ≤0.22 KWh/Kg; and
(c) an extrusion screw Rotation Per Minute (RPM) of about ≥240 and ≤260.

In a preferred embodiment of the disclosure, the material throughput is adjusted to be maintained between ≥8.0 Kg/hour and ≤30.0 Kg/hour, ≥8.0 Kg/hour and ≤25.0 Kg/hour, preferably the specific mechanical energy (SME) between 0.15 kWh/t and 0.22 kWh/t, while keeping the screw RPM at 250.

In some embodiments of the disclosure, injection molding may be conducted at an injection molding temperature of ≥210.0° C. and ≤250.0° C., preferably ≥215.0° C. and ≤240.0° C., more preferably ≥220° C. and ≤230° C. and at an injection speed was maintained at ≥10.0 mm/sec and ≤40.0 mm/sec, preferably ≥15 mm/sec and ≤35.0 mm/sec, more preferably ≥25.0 mm/sec and ≤30.0 mm/sec.

### Surface Treated Polymeric Article

Illustrative embodiments of the present disclosure are directed to a surface treated polymeric article obtainable by a method comprising the steps of:
a. providing the polymeric article according to one or more embodiments of the present disclosure; and
b. contacting at least a portion of the polymeric article with a chemical reagent for any time period between ≥5.0 minutes and ≤30.0 minutes, preferably ≥10.0 minutes and ≤20.0 minutes, preferably ≥15.0 minutes and ≤20.0 minutes and at a temperature of ≥60.0° C. and ≤80.0° C., preferably ≥65.0° C. and ≤75.0° C., and forming the surface treated polymeric article.

It is preferred that the polymeric article used for forming the surface treated polymeric article, comprises the thermoplastic polymer composition, wherein the thermoplastic polymer composition consists of or consists essentially of:
a. a copolymer (A) present in an amount of ≥35.0 wt. % and ≤70.0 wt. %, with regard to the total weight of the thermoplastic polymer composition, wherein the copolymer (A) consists of polymeric units derived from (i) a vinyl aromatic monomer, and (ii) a vinyl nitrile monomer;
b. a rubber modified thermoplastic polymer (E) present in an amount of ≥26.0 wt. % and ≤50.0 wt. %, preferably ≥30.0 wt. % and ≤50.0 wt. %, with regard to the total weight of the thermoplastic polymer composition;
c. a functionalized polymer (FP), present in an amount of ≥1.0 wt. % and ≤15.0 wt. %, preferably ≥3.0 wt. % and ≤12.0 wt. %, with regard to the total weight of the thermoplastic polymer composition, wherein the functionalized polymer (FP) is any one polymer selected from styrene maleic anhydride (SMA) copolymer or maleic anhydride grafted polystyrene (MA-g-PS), preferably the functionalized polymer (FP) is styrene maleic anhydride (SMA) copolymer; and
d. an additive mixture present in an amount of ≥0.0 wt. % and ≤5.0 wt. %, with regard to the total weight of the thermoplastic polymer composition.

The surface treated polymeric article may comprise the thermoplastic polymer composition in an amount of ≥95.0 wt. %, preferably ≥96.0 wt. %, preferably ≥99.0 wt. %, preferably 100 wt. % with regard to the total weight of the surface treated polymeric article.

More preferably, the polymeric article is contacted with a chemical reagent for any time period between ≥15.0 minutes and ≤20.0 minutes and at a temperature of ≥65.0° C. and ≤75.0° C. The surface treated polymeric article has a suitable surface polarity while retaining the desired impact strength. The attributes of surface polarity and impact strength may for example be attributed to a purposeful combination of a suitable polymeric article, a suitable selection of chemical reagent and a suitable process parameters of temperature and time period of contact/exposure.

Illustrative embodiments of the present disclosure are directed to a surface treated polymeric article, comprising the polymeric article in accordance with one or more embodiments of the present disclosure, wherein the surface treated article has a water contact angle of ≥60.0° and ≤85.0°, preferably ≥65.0° and ≤80.0°, preferably ≥650 and ≤750 as determined in accordance with ASTM D5946-17.

Advantageously, the surface treated polymeric article has a sufficiently low water contact angle indicative of suitable surface polar functionality as may be required for the polymeric article to adhere to a metal layer.

Preferably, the surface treated polymeric article is able to retain the impact property of the polymeric article even after the surface treatment with the chemical reagent. For example, the surface treated polymeric article has a Notched Izod Impact strength of ≥15.0 kJ/m² and ≤50.0 kJ/m², preferably ≥20.0 kJ/m² and ≤40.0 kJ/m², preferably ≥20.0 kJ/m² and ≤30.0 kJ/m², when measured in accordance with ISO 180/1A.

Accordingly, in some embodiments of the disclosure, the surface treated polymeric article has:
a. a Notched Izod Impact strength of ≥15.0 kJ/m² and ≤50.0 kJ/m², preferably ≥20.0 kJ/m² and ≤40.0 kJ/m², preferably ≥20.0 kJ/m² and ≤30.0 kJ/m², when measured in accordance with ISO 180/1A; and
b. the surface treated polymeric article has a water contact angle of ≥60.0° and ≤85.0°, preferably ≥65.0° and ≤80.0°, preferably ≥650 and ≤75° as determined in accordance with ASTM D5946-17.

Illustrative embodiments of the present disclosure are directed to a surface treated polymeric article comprising a thermoplastic polymer composition, wherein the thermoplastic polymer composition comprises, consists of, or consists essentially of:
a. the copolymer (A) present in amount of ≥35.0 wt. % and ≤70.0 wt. %, preferably ≥40.0 wt. % and ≤60.0 wt. %, preferably ≥45.0 wt. % and ≤56.0 wt. %, with regard to the total weight of the thermoplastic polymer composition, wherein the copolymer (A) is styrene-acrylonitrile copolymer (SAN);
b. the rubber modified thermoplastic polymer (E), present in an amount of ≥26.0 wt. % and ≤50.0 wt. %, preferably ≥30.0 wt. % and ≤50.0 wt. %, preferably ≥30.0 wt. % and ≤45.0 wt. %, preferably ≥35.0 wt. % and ≤45.0 wt. %, with regard to the total weight of the thermoplastic polymer composition, wherein the rubber modified thermoplastic polymer (E) is polybutadiene rubber grafted with styrene, methyl methacrylate, acrylonitrile copolymer;
c. the functionalized polymer (FP) present in an amount of ≥1.0 wt. % and ≤15.0 wt. %, preferably ≥3.0 wt. % and ≤12.0 wt. %, preferably ≥6.0 wt. % and ≤12.0 wt. %, with regard to the total weight of the thermoplastic polymer composition, wherein the functionalized polymer (FP) is styrene maleic anhydride (SMA) copolymer; and
d. an additive mixture present in an amount of ≥0.0 wt. % and ≤5.0 wt. %, preferably ≥1.0 wt. % and ≤5.0 wt. %, preferably ≥1.0 wt. % and ≤3.0 wt. %, with regard to the total weight of the thermoplastic polymer composition; wherein the surface treated polymeric article has:
   i. a Notched Izod Impact strength of ≥15.0 kJ/m² and ≤50.0 kJ/m², preferably ≥20.0 kJ/m² and ≤40.0 kJ/m², preferably ≥20.0 kJ/m² and ≤30.0 kJ/m², when measured in accordance with ISO 180/1A; and/or
   ii. a water contact angle of ≥60.0° and ≤85.0°, preferably ≥65.0° and ≤80.0°, preferably ≥65° and ≤750 as determined in accordance with ASTM D5946-17, further wherein the additive mixture comprises or consists of magnesium oxide (MgO), silicone oil, wax and magnesium stearate.

The inventors found that the water contact angle of the surface treated polymeric article was lower than the polymeric article itself, indicating improved surface wettability and thereby higher propensity to adhere to a metal layer.

Illustrative embodiments of the present disclosure are directed to a method for producing the surface treated polymeric article in accordance with one or more embodiments of the present disclosure, wherein the method, comprises the steps of:
a. providing the polymeric article of claims in accordance with one or more embodiments of the present disclosure; and
b. contacting the polymeric article in accordance with one or more embodiments of the present disclosure with a chemical reagent for any time period between ≥5.0 minutes and ≤30.0 minutes, preferably ≥10.0 minutes and ≤20.0 minutes, preferably ≥15.0 minutes and ≤20.0 minutes and at a temperature condition of ≥60.0° C. and ≤80.0° C., preferably ≥65.0° C. and ≤75.0° C., and forming the surface treated polymeric article.

Advantageously, the surface treated polymeric article was produced without the use of hexavalent chromium compounds thereby avoiding all of the drawbacks which are currently associated with the conventional etching process using such hexavalent chromium compounds.

The polymeric article may for example be contacted with the chemical reagent for a suitable period of time in order to ensure the desired surface roughness is incorporated. For example, if the time period of contacting the polymeric article with the chemical reagent is too high (high exposure time), the surface of the polymeric article may be damaged while if the polymeric article is in contact with the chemical reagent is for too short a time, the surface morphology of the polymeric article is not sufficiently altered to enable the adhesion of the surface treated polymeric article to a metal layer.

The chemical reagent may for example be selected from a sulfuric acid solution having 70.0% volume concentration, a colloidal solution comprising manganese oxide colloidal particles suspended in a mineral acid mixture, potassium permanganate solution having 6.5% volume concentration and any combinations thereof. More preferably the chemical reagent is a colloidal solution comprising manganese oxide colloidal particles suspended in a mineral acid mixture comprising sulfuric acid and phosphoric acid.

Preferably, the colloidal solution comprising manganese oxide colloidal particles suspended in a mineral acid mixture, comprises:
a. manganese oxide colloidal particles present in an amount of ≥50.0 g/L and ≤70.0 g/L, preferably ≥55.0 g/L and ≤65.0 g/L;
b. phosphoric acid present in an amount of ≥210.0 ml/L and ≤230.0 ml/L, preferably ≥215.0 ml/L and ≤225.0 ml/L; and
c. sulfuric acid present in an amount of ≥560.0 ml/L and ≤580.0 ml/L, preferably ≥570.0 ml/L and ≤575.0 ml/L;
   wherein the total volume of the colloidal solution is 1.0 litre (L).

The chemical reagent may for example comprise a sulfuric acid (H₂SO₄) having a molar strength of ≥8.0 M and ≤14.0 M, preferably ≥9.0 M and ≤12.0 M. The chemical reagent may for example comprise a phosphoric acid may for example have a molar strength of ≥2.0 M and ≤6.0 M, preferably ≥3.0 M and ≤5.0 M.

The inventors surprisingly found that when the polymeric article of the present disclosure is treated at a specific temperature and for a specific time period with a suitable chemical reagent, the resultant surface treated polymeric article has the desired surface roughness and polar functionalities, which is comparable to a polymeric surface etched with a hexavalent chromium compound.

In other words, the surface treated polymeric article in accordance with one or more embodiments of the present disclosure, has a surface texture suitable for metal plating even without the use of hexavalent chromium compound. For example, if the chemical reagent was contacted for an exposure time period of less than 5 minutes, the desired surface roughness and polar functionalities required for metal adhesion may not be obtained while if the article was exposed to a chemical reagent for an exposure time beyond 30 minutes, the surface of the plastic article may be damaged.

### Metal Plated Article

An aspect of the present disclosure is directed to a metal plated article comprising:
a. a metal layer; and
b. a polymeric substrate layer comprising the surface treated polymeric article in accordance with one or more embodiments of the present disclosure; wherein the metal layer is disposed on the polymeric substrate layer, preferably the metal layer is adhered to a treated surface of the polymeric substrate layer. The expression “treated surface” as used herein means a portion of the polymeric substrate layer or the surface treated polymeric article that has been exposed to the chemical reagent for the surface treatment.

The metal layer is adhered to the treated surface of the polymeric substrate layer at a peel strength of ≥0.14 N/mm, preferably ≥0.16 N/mm, preferably ≥0.2 N/mm, preferably ≥0.3 N/mm, preferably ≥0.34 N/mm, as determined in accordance with ASTM B 533-85 (2004).

Preferably, the metal layer is adhered to the treated surface of the polymeric substrate layer at a peel strength of ≥0.14 N/mm and ≤2.0 N/mm, preferably ≥0.16 N/mm and ≤2.0 N/mm, preferably ≥0.2 N/mm and ≤1.5 N/mm, preferably ≥0.3 N/mm and ≤1.5 N/mm, as determined in accordance with ASTM B 533-85 (2004).

The peel strength is a suitable indicator of adhesion of the polymeric substrate to the metal layer. The inventors believe that the surface treated article has a suitable surface roughness and polarity, which impart the desired anchoring points on the surface of the article, rendering the article to be suitable for use as a polymer substrate for metal plating.

The surface roughness may for example be determined using a DektakXT contact surface profilometer that measures the surface roughness in thin and thick films using a mechanical stylus. The roughness of the surface treated polymeric article may for example be determined using a mechanical stylus having for example a 12.5 μm radius tip that may be lowered to be in contact with the article surface under a load adjustable from 1 mg to 15 mg. The article may be displaced towards the operator in the horizontal plane over a distance for example up to 55 mm. A software, for example Vision64 application, may be used to determine the roughness of the given article by calculating and displaying the results of hills and valleys for surface texture.

The metal plated article may for example be produced by a combination of chemical plating and electroplating. For example, the process for producing the metal plated article, comprising the steps of:
a. providing the surface treated polymeric article in accordance with one or more embodiments of the present disclosure;
b. subjecting the surface treated polymeric article to chemical plating to form a metal plated precursor article; and
c. contacting the metal plated precursor article with a metal electrolyte solution at any applied electric current of ≥1.0 Amps and ≤4.0 Amps, and for a time period of ≥5 minutes and ≤30 minutes, and forming the metal plated article.

The chemical plating may for example include the step of (i) sensitizing the surface treated polymeric article with a suitable sensitizing solution for example a solution of SnCl₂/HCl followed by activation with an activating solution for example a solution of PdCl₂/HCl to form an activated article, (ii) thereafter treating the activated article with monosodium phosphate (NaH₂PO₄), and a chemical plating solution to obtain the metal plated precursor article.

The chemical plating solution may for example comprise CuSO₄·5H₂O (15 g/L), NaKC₄H₄O₆·4H₂O (30 g/L), HCHO (100 ml/L) and NaOH (4 g/L). Alternatively, the chemical plating solution may for example comprise NiSO₄·6H₂O (15 g/L), NaKC₄H₄O₆·4H₂O (30 g/L), HCHO (100 ml/L) and NaOH (4 g/L). The metal electrolyte for example may be selected from nickel sulfate, copper sulfate, aluminum salts such as aluminum chloride or aluminum sulfate, zinc based salts such as zinc sulfate or zinc chloride, silver salts such as silver sulfate or silver chloride and mixtures of metal salts.

The chemical plating process resulted in the formation of the metal plated precursor article. The metal plated precursor article has a suitable conductivity as required for carrying out the electroplating process. The metal layer may for example be copper based layer, an aluminum based layer, a nickel based layer, a zinc based layer, a gold based layer, or a silver based layer, or metal alloy based layer, preferably the metal layer is a copper based layer. The metal alloy may for example be selected from brass.

The metal plated article for example may be selected from an automotive component, a housing structure for electrical appliances.

Specific examples demonstrating some of the embodiments of the disclosure are included below. The examples are for illustrative purposes only and are not intended to limit the invention. It should be understood that the embodiments and the aspects disclosed herein are not mutually exclusive and such aspects and embodiments can be combined in any way. Those of ordinary skill in the art will readily recognize parameters that can be changed or modified to yield essentially the same results.

### EXAMPLE

### Example 1

Purpose: To demonstrate the features of the present disclosure the following samples were prepared to evaluate the peel strength of the metal layer to a polymeric substrate. The polymeric samples with sample codes D13, D21, and D22 are inventive having a thermoplastic polymer composition in accordance with one or more embodiments of the present disclosure and the chemical reagent used for preparing the surface modified polymeric article is manganese oxide colloidal particles suspended in a mineral acid mixture comprising sulfuric acid and phosphoric acid. The samples D20, D14 and EC2 are comparative samples. The sample EC2 does not contain any functionalized polymer. All the samples were surface treated with a chemical reagent H₃PO₄ (4.2 M)-H₂SO₄ (9.4 M)-MnO₂ (60 g/L) colloids.

Sample Material: The various materials used are as provided below:

TABLE 1

| Material | Description | Supplier/Grade/CAS No. |
|---|---|---|
| Copolymer A | Styrene-acrylonitrile copolymer (SAN) | |
| Rubber modified thermoplastic | Polybutadiene rubber grafted with | INP362 |
| polymer (E) | styrene/methyl methacrylate/ | |
| | acrylonitrile copolymer. | |
| | (a) Polymeric rubber - Polybutadiene | |
| | derived from 1.3 butadiene (~62% with | |
| | regard to the total weight of the rubber | |
| | modified thermoplastic (E)). | |
| | (b) Grafting thermoplastic copolymer | |
| | (C) - styrene/methyl methacrylate/ | |
| | acrylonitrile copolymer (~38% with | |
| | regard to the total weight of the rubber | |
| | modified thermoplastic (E)). | |
| Functionalized Polymer | Styrene maleic anhydride (SMA) | XB280 from |
| | copolymer. | Polyscope. |
| Additive mixture | Magnesium Oxide (MgO), Silicone oil, | Sigma Aldrich |
| | EBX wax, Magnesium Stearate. | |
| Chemical reagent used for | H₃PO₄ (4.2M)-H₂SO₄ (9.4M) - MnO₂ | Phosphoric acid (7664- |
| preparing the surface treated | (60 g/L) | 38-2) from Sigma |
| polymeric article. | | Aldrich |
| | | Sulfuric acid (7664-93- |
| | | 9) from Sigma Aldrich |
| | | Manganese Oxide |
| | | (1313-13-9) from |
| | | Acros |
| Sensitizing Solution for | SnCl₂/HCl | Sigma Aldrich |
| chemical plating | | |
| Activating Solution for | PdCl₂/HCl | Sigma Aldrich |
| electroplating | | |
| Chemical plating solution | CuSO₄•5H₂O (15 g/L), | Sigma Aldrich |
| | NaKC₄H₄O₆•4H₂O (30 g/L), HCHO | |
| | (100 ml/L) and NaOH (4 g/L) | |

The sample details in terms of composition is as given below. All samples were prepared with a total weight of 4.0 kg.

TABLE 2

| | D22 | D21 | D13 | D20 | D14 | EC2 |
|---|---|---|---|---|---|---|
| | (Inventive) | (Inventive) | (Inventive) | (Comparative) | (Comparative) | (Comparative) |
| Copolymer A | 48.46 | 55.46 | 48.46 | 63.46 | 63.46 | 73.46 |
| (wt. %) | | | | | | |
| Rubber | 40.0 | 40.0 | 40.0 | 25.0 | 25.0 | 25.0 |
| modified | | | | | | |
| thermoplastic | | | | | | |
| polymer (E) | | | | | | |
| (wt. %) | | | | | | |
| Functionalized | 10.0 | 3.0 | 10.0 | 10.0 | 10.0 | 0.0 |
| Polymer | | | | | | |
| (wt. %) | | | | | | |
| Additive | 1.54 | 1.54 | 1.54 | 1.54 | 1.54 | 1.54 |
| mixture | | | | | | |
| (wt. %) | | | | | | |
| Total (wt. %) | 100 | 100 | 100 | 100 | 100 | 100 |

The additive mixture comprises 0.04 wt. % of magnesium oxide, 0.2 wt. % of silicone oil, 1.0 wt. % EBX wax, and 0.3 wt. % of magnesium stearate, with regard to the total weight of the sample.

The details of the acrylonitrile content and maleic anhydride content are provided in the table below:

TABLE 3

| | D22 | D21 | D13 | D20 | D14 |
|---|---|---|---|---|---|
| | (Inventive) | (Inventive) | (Inventive) | (Comparative) | (Comparative) |
| Maleic anhydride | 32.0 | 32.0 | 32.0 | 32.0 | 32.0 |
| content with | | | | | |
| regard to the total | | | | | |
| weight of the | | | | | |
| Functionalized | | | | | |
| Polymer (wt. %) | | | | | |
| Acrylonitrile | 34.0 | 34.0 | 25.0 | 34.0 | 34.0 |
| content with | | | | | |
| regard to the total | | | | | |
| weight of the | | | | | |
| Copolymer (A) | | | | | |
| (wt. %) | | | | | |
| Weight average | 15000 | 15000 | 15000 | 15000 | 15000 |
| Molecular weight | | | | | |
| of Functionalized | | | | | |
| Polymer (g/mol) | | | | | |

Process for preparing the polymeric article (sample plaques): For preparing the samples, a combination of extrusion and injection molding processes were used.

Extrusion process: All formulations were prepared in a 4.0 Kg scale. A mixture of styrene acrylonitrile (SAN) pellets and the functionalized polymer styrene maleic anhydride (SMA) copolymer were added through a hopper/feeder while a pre-blend of 1) the rubber modified thermoplastic polymer (E) (polybutadiene rubber particles grafted with styrene/methyl methacrylate/acrylonitrile copolymer also referred to as HRG) and 2) additive mixture comprising EBX wax, magnesium stearate, magnesium oxide and silicone fluid were fed through the side feeder connected to barrel 2 of the extruder.

Control sample (EC2) was prepared by mixing equal amounts of two different grades of the Copolymer (A)—styrene acrylonitrile SAN556 (acrylonitrile content of 34.0 wt. %) and SAN581 (acrylonitrile content of 25.0 wt. %) without any functional additives. Prior to loading in the hopper, the pellets SMA and SAN were pre-mixed (physical mixing) together in a plastic container to obtain a homogeneous mix of the pellets. Similarly, the pre-blend in the form a homogeneous powder was obtained by dry-blending (physical mixing) the rubber modified thermoplastic polymer (E) and the additive mixture in a separate container.

The physically mixed formulations comprising the copolymer (A), the rubber modified thermoplastic polymer (E), the functionalized polymer once introduced in the extruder were melt blended in a 10-barrel Coperion ZSK-26 mm co-rotating twin-screw extruder whose L/D ratio is 40:1. During the extrusion process, the material throughput was adjusted to maintain the specific mechanical energy (SME) between 0.15 KWh/Kg and 0.22 KWh/Kg, while keeping the screw RPM at 250.

The parameters for extrusion process are provided in the table below:

TABLE 4

| | D22 | D21 | D13 | D20 | D14 | EC2 |
|---|---|---|---|---|---|---|
| | (Inventive) | (Inventive) | (Inventive) | (Comparative) | (Comparative) | (Comparative) |
| Torque | 64-68 | 44-46 | 54-56 | 52-55 | 65-68 | 60-62 |
| RPM | 250 | 250 | 250 | 250 | 250 | 250 |
| Throughput | 24.0 | 12.0 | 14.0 | 19.0 | 20.0 | 19.0 |
| kg/h | | | | | | |
| Specific | 0.15 | 0.22 | 0.22 | 0.15 | 0.18 | 0.18 |
| Mechanical | | | | | | |
| Energy | | | | | | |
| (SME) | | | | | | |
| (kWh/t) | | | | | | |
| Screw | Mild | Mild | Harsh | Mild | Harsh | Harsh |
| design | | | | | | |

For harsh screw design, such a screw has extra neutral kneading block and a small back-conveying element while mild screw design has small back-conveying kneading block. The temperature profile of the extrusion barrel is as provided below:

TABLE 5

| Barrel | 1^{st} | 2^{nd} | 3^{rd} | 4^{th} | 5^{th} | 6^{th} | 7^{th} | 8^{th} | 9^{th} | 10^{th} |
|---|---|---|---|---|---|---|---|---|---|---|
| Temp ° C. | 170 | 204 | 225 | 230 | 240 | 240 | 240 | 240 | 240 | 245 |

Injection molding process: The injection molding process was carried out in an L&T Detech, 100 Ton molding equipment fitted with 32 mm diameter screw. The molded parts were kept for conditioning for 72 hours at 23° C. and at a relative humidity (R_{H}) of 50%. After the conditioning, impact strength testing was conducted for all the molded formulations.

TABLE 6

| | D22 | D21 | D13 | D20 | D14 | EC2 |
|---|---|---|---|---|---|---|
| | (Inventive) | (Inventive) | (Inventive) | (Comparative) | (Comparative) | (Comparative) |
| Injection | 240.0 | 240.0 | 215.0 | 215.0 | 240.0 | 215.0 |
| molding | | | | | | |
| temperature | | | | | | |
| (° C.) | | | | | | |
| Injection | 30.0 | 15.0 | 30.0 | 30.0 | 7.6 | 15.0 |
| speed | | | | | | |
| (mm/sec) | | | | | | |

The resultant polymeric article obtained by the molding process was tested for its Notched Izod Impact strength in accordance with ISO 180/1A, the result of which is provided below:

TABLE 7

| | D22 | D21 | D13 | D20 | D14 | EC2 |
|---|---|---|---|---|---|---|
| | (Inventive) | (Inventive) | (Inventive) | (Comparative) | (Comparative) | (Comparative) |
| Notched | 20.54 | 30.94 | 21.14 | 10.0 | 22.83 | 14.5 |
| Izod | | | | | | |
| Impact | | | | | | |
| strength | | | | | | |
| (kJ/m²) | | | | | | |

From the above table, it is evident that the inventive polymeric article or the sample plaque, prepared from the thermoplastic polymer composition in accordance with one or more embodiments of the present disclosure, has the desired impact property.

Process for preparing the surface treated polymeric article (referred to as a pretreatment step): The polymeric article or sample plaques, once obtained from the above process were contacted with a chemical reagent comprising H₃PO₄ (4.2 M)-H₂SO₄ (9.4 M)-MnO₂ (60 g/L). The time period for the treatment was maintained at 20 minutes and the temperature condition was maintained at 70° C. to obtain the surface treated polymeric article.

The water contact angle for the surface treated polymeric article was measured in accordance with ASTM D5946 while Notched Izod Impact strength was measured in accordance with ISO 180/1A. The results are as provided below:

TABLE 8

| | D22 | D21 | D13 | D20 | D14 | EC2 |
|---|---|---|---|---|---|---|
| | (Inventive) | (Inventive) | (Inventive) | (Comparative) | (Comparative) | (Comparative) |
| Water | 69° | NA | 82° | 80° | 87º | 78° |
| Contact | | | | | | |
| Angle | | | | | | |
| (degree) | | | | | | |
| Notched | 20.54 | 30.94 | 21.14 | 10.0 | 22.83 | 14.5 |
| Izod | | | | | | |
| Impact | | | | | | |
| strength | | | | | | |
| (KJ/m²) | | | | | | |
| Domain | Uniform | Uniform | Uniform | Non-uniform | Non-uniform | Non-uniform |
| size | | | | | | |
| evaluation | | | | | | |
| through | | | | | | |
| SEM | | | | | | |
| analysis | | | | | | |

From Table 8, the surface treated polymeric article has the requisite water contact angle and is able to retain the desired impact property. It was further observed that the surface treated article has a lower water contact angle than the starting polymeric article prior to the pretreatment step indicating improved surface wettability and thereby better suited for adhesion to a metal layer. For example, a surface treated article derived from the polymeric article/sample plaque of D22 has nearly 43% lower water contact angle compared to the polymeric article D22 prior to the surface treatment while the surface treated article D13 has nearly 13% lower water contact angle after the surface treatment.

It was further observed that there was no significant change in the surface morphology during the initial 5 minutes after contact with the chemical reagent. However, a significant change in the surface morphology was evident with further increase of exposure time.

For instance, when the molded plaques of D13 or D22 were pretreated for 20 minutes using H₃PO₄ (4.2 M)-H₂SO₄ (9.4 M)-MnO₂ (60 g/L), the number of cavities on the surface increased and the shape thus formed resembled that of typical hexachrome etched sample.

These findings indicates that treatment of the substrates with manganese oxide colloids with a high concentration of sulfuric acid/phosphoric acid for a period of 20 minutes leads to the formation of many cavities. However, with a higher exposure time beyond 30 min or in certain instances beyond 20 minutes, the surface of the polymeric article was observed to be damaged significantly.

Process for producing the metal plated article: The surface treated polymeric article once obtained was plated with a metal layer. For the purposes of the present example, the metal layer was a copper layer. The process of depositing the metal layer on the surface treated polymeric article involved a combination of process involving the steps of 1) chemical plating followed by 2) electroplating to obtain the metal plated article as the final product.

Chemical Plating process: The chemical plating process involved the step of introducing the surface treated polymer article in a plating bath where metal ions in the plating bath were reduced and were bound to the polar groups on the article surface to form a metallic layer. During the chemical plating process all the samples were sensitized in SnCl₂ (10 g/L)/HCl (40 ml/L) solution (sensitizing solution) and followed by activation using PdCl₂ (0.25 g/L)/HCl (2.5 ml/L) solution (activated solution). Post the activation, the samples were treated for 15 minutes in a chemical plating bath solution containing CuSO₄·5H₂O (15 g/L), NaKC₄H₄O₆·4H₂O (30 g/L), HCHO (100 ml/L) and NaOH (4 g/L) to obtain the metal plated precursor article, which were subsequently electroplated.

### Electroplating Process:

The electroplating process involved a electrodeposition process step where copper layer was deposited layer by layer on the metal plated precursor article step using MiniContact RS Electroplating System. During the process, a copper metal based electrolyte solution comprising 75 g/l copper sulfate and 200 ml/l sulfuric acid was used. The applied current was maintained at 1.5 Amps and the temperature was 29° C. The electroplating time was maintained for 30 min to obtain the metal plated article.

Results: The metal plated article once obtained, was evaluated for the extent of adhesion of the metal layer (copper layer) to the polymer substrate comprising the surface treated polymeric article for each of the samples. The peel strength was determined in accordance with in accordance with ASTM B 533-85 (2004). The result of the peel strength are provided below:

| | D22 | D21 | D13 | D20 | D14 | EC2 |
|---|---|---|---|---|---|---|
| | (Inventive) | (Inventive) | (Inventive) | (Comparative) | (Comparative) | (Comparative) |
| Peel | 0.34 | 0.21 | 0.26 | 0.14 | 0.0 | 0.09 |
| Strength | | | | | | |
| (N/mm) | | | | | | |

From the results obtained above it is evident that the metal plated article, which has a polymeric substrate derived from the sample D22, demonstrated the highest peel strength indicative of high degree of adhesion between the metal layer (copper) and the polymeric substrate. Advantageously, the polymeric substrate has an excellent impact property as well thereby imparting the desired impact property to the metal plated article.

The metal plated article derived from the sample D13, has over 90% higher peel strength than the peel strength of the metal plated article derived from the sample D20 and nearly 127% higher peel strength than that of the sample EC2 (where sample EC2 does not contain any functionalized polymer).

### Example 2 (Comparative)

Purpose: As an alternate approach, some of the samples were surface treated with certain alternate chemical reagents, which were different from that used in Example 1. The surface treated polymeric article so obtained were plated using the same process as described in Example 1. Subsequently, the peel strength was evaluated for each of the metal plated articles so obtained. The thermoplastic polymer composition constituting each sample is identical to that used in Example 1.

| | | Temperature at | Time at | |
|---|---|---|---|---|
| | Chemical | which surface | which surface | Peel Strength |
| | reagent | treatment was | treatment was | of the metal |
| Sample | for surface | carried out | carried out | plated article |
| Code | treatment | (° C.) | (minutes) | (N/mm) |
| D13 | 40% H₂SO₄ | 23° C. | 15.0 | 0.002 |
| D13 | 70% H₂SO₄ | 23° C. | 15.0 | 0.07 |
| D13 | 5% KMnO₄ | 80° C. | 15.0 | 0.014 |
| D13 | 6.5% KMnO₄ | 23° C. | 15.0 | 0.009 |
| D13 | 70% H₂SO₄ | 60° C. | 20.0 | 0.011 |
| D13 | 70% H₂SO₄ | 60° C. | 15.0 | 0.0 |
| D22 | 6.5% KMnO₄ | 23° C. | 15.0 | 0.007 |
| EC2 | 70% H₂SO₄ | 23° C. | 15.0 | 0.19 |
| EC2 | 40% H₂SO₄ | 23° C. | 15.0 | 0.002 |

From the above table it is evident that none of the samples when treated with the reagents such as 70% H₂SO₄, 6.5% KMVnO₄ or 5% KMnO₄ resulted in the desired surface treated polymeric article which had the requisite adhesion characteristics.

From the results obtained from Example 1 and Example 2, it is evident that only when a polymeric article comprising a suitable thermoplastic polymer composition is surface treated under a suitable conditions with a suitable chemical reagent, that such a treatment resulted in a surface treated article having the desired surface roughness and morphology required for metal plastic adhesion.

1. A polymeric article, comprising:
a thermoplastic polymer composition, wherein the thermoplastic polymer composition comprises:
a copolymer (A) present in an amount of ≥35.0 wt. % and ≤70.0 wt. %, with regard to the total weight of the thermoplastic polymer composition, wherein the copolymer (A) comprises polymeric units derived from (i) a vinyl aromatic monomer, and (ii) a vinyl nitrile monomer;
a rubber modified thermoplastic polymer (E) present in an amount of ≥26.0 wt. % and ≤50.0 wt. % with regard to the total weight of the thermoplastic polymer composition;
a functionalized polymer (FP), present in an amount of ≥1.0 wt. % and ≤15.0 wt. %, with regard to the total weight of the thermoplastic polymer composition, wherein the functionalized polymer (FP) comprises styrene maleic anhydride (SMA) copolymer or maleic anhydride grafted polystyrene (MA-g-PS); and
an additive mixture present in an amount of ≥0.0 wt. % and ≤5.0 wt. %, with regard to the total weight of the thermoplastic polymer composition.

2. The polymeric article of claim 1, wherein the copolymer (A) is present in an amount of ≥40.0 wt. % and ≤60.0 wt. % with regard to the total weight of the thermoplastic polymer composition,
wherein the rubber modified thermoplastic polymer (E) is present in an amount of ≥30.0 wt. % and ≤45.0 wt. % with regard to the total weight of the thermoplastic polymer composition,
wherein the functionalized polymer (FP) is present in an amount of ≥3.0 wt. % and ≤12.0 wt. % with regard to the total weight of the thermoplastic polymer composition, and
wherein the additive mixture is present in an amount of ≥1.0 wt. % and ≤5.0 wt. % with regard to the total weight of the thermoplastic polymer composition.

3. The polymeric article of claim 1, wherein the functionalized polymer (FP) comprises:
a maleic anhydride content of ≥10.0 wt. % and ≤45.0 wt. % with regard to the total weight of the functionalized polymer (FP); and
a weight average molecular weight of ≥1,000 g/mol and ≤25,000 g/mol when determined in accordance with ASTM D5296-11.

4. The polymeric article according to claim 1, wherein the vinyl aromatic monomer is selected from the group consisting of styrene, α-methyl styrene, dibromostyrene, vinyltoluene, vinylxylene, butylstyrene, and p-hydroxystyrene, methoxystyrene, preferably the vinyl aromatic monomer is styrene, and
wherein the vinyl nitrile monomer is selected from the group consisting of acrylonitrile, alpha-chloro acrylonitrile, methacrylonitrile, and ethacrylonitrile.

5. The polymeric article according to claim 1, wherein the rubber modified thermoplastic polymer (E), comprises:
a polymeric rubber comprising polymeric units derived from a conjugated diene, wherein the conjugated diene is selected from the group consisting of 1,3-butadiene, isoprene, 1,3-heptadiene, methyl-1,3-pentadiene, 2,3-dimethyl-1,3-butadiene, 2-ethyl-1,3-pentadiene, 1,3-hexadiene, 2,4-hexadiene, and any combination thereof;
a grafting thermoplastic copolymer (C), wherein the grafting thermoplastic copolymer (C) is grafted to the polymeric rubber, and wherein the grafting thermoplastic copolymer (C) comprises polymeric units derived from:
a vinyl aromatic monomer selected from styrene, α-methyl styrene, dibromostyrene, vinyltoluene, vinylxylene, butylstyrene, p-hydroxystyrene, methoxystyrene, and any combination thereof, preferably the vinyl aromatic monomer is styrene;
a vinyl nitrile monomer selected from acrylonitrile, methacrylonitrile, ethacrylonitrile, and any combinations thereof, preferably the vinyl nitrile monomer is acrylonitrile; and
a (meth)acrylic monomer selected from methyl methacrylate, ethyl methacrylate, methyl acrylate, ethyl acrylate, propyl acrylate, and propyl methacrylate, preferably the (meth)acrylic monomer is methyl methacrylate (MMA).

6. The polymeric article according to claim 1, wherein the thermoplastic polymer composition comprises:
the copolymer (A) present in amount of ≥45.0 wt. % and ≤56.0 wt. %, with regard to the total weight of the thermoplastic polymer composition, wherein the copolymer (A) is styrene-acrylonitrile copolymer (SAN);
the rubber modified thermoplastic polymer (E), present in an amount of ≥35.0 wt. % and ≤45.0 wt. %, with regard to the total weight of the thermoplastic polymer composition, wherein the rubber modified thermoplastic polymer (E) is polybutadiene rubber grafted with styrene/methyl methacrylate/acrylonitrile/copolymer; and
the functionalized polymer (FP) present in an amount of ≥6.0 wt. % and ≤12.0 wt. %, with regard to the total weight of the thermoplastic polymer composition, wherein the styrene maleic anhydride (SMA) copolymer has:
the maleic anhydride content of ≥15.0 wt. % and ≤40.0 wt. % with regard to the total weight of the styrene maleic anhydride (SMA) copolymer; and
the weight average molecular weight of ≥2,000 g/mol and ≤20,000 g/mol when determined in accordance with ASTM D5296-11; and
the additive mixture present in an amount of ≥1.0 wt. % and ≤3.0 wt. %, with regard to the total weight of the thermoplastic polymer composition.

7. A method for producing a polymeric article, the method comprising:
introducing in an extruder, a set of ingredients comprising:
a copolymer (A) in an amount of ≥35.0 wt. % and ≤70.0 wt. %, with regard to the total weight of the thermoplastic polymer composition, wherein the copolymer (A) comprises polymeric units derived from (i) a vinyl aromatic monomer, and (ii) a vinyl nitrile monomer,
a rubber modified thermoplastic polymer (E) in an amount of ≥26.0 wt. % and ≤50.0 wt. % with regard to the total weight of the thermoplastic polymer composition,
a functionalized polymer (FP) in an amount of ≥1.0 wt. % and ≤15.0 wt. %, with regard to the total weight of the thermoplastic polymer composition, wherein the functionalized polymer (FP) is styrene maleic anhydride (SMA) copolymer or maleic anhydride grafted polystyrene (MA-g-PS), and
an additive mixture in an amount of ≥0.0 wt. % and ≤5.0 wt. %, with regard to the total weight of the thermoplastic polymer composition to obtain an extrudable composition;
extruding the extrudable composition under conditions of extrusion and forming a set of extruded pellets; and
subjecting the set of extruded pellets to injection molding under conditions of:
an injection molding temperature of ≥210.0° C. and ≤250.0° C.; and
an injection speed of ≥10.0 mm/sec and ≤40.0 mm/sec; and
forming the polymeric article.

8. The method of claim 7 further comprising:
contacting at least a portion of the polymeric article with a chemical reagent for a time period between ≥5.0 minutes and ≤30.0 minutes; and
forming a surface treated polymeric article.

9. The method of claim 8, wherein the chemical reagent is a colloidal solution comprising manganese oxide colloidal particles suspended in a mineral acid mixture comprising sulfuric acid and phosphoric acid.

10. The method of claim 9, wherein the colloidal solution comprising manganese oxide colloidal particles suspended in a mineral acid mixture, comprises:
manganese oxide colloidal particles present in an amount of ≥50.0 g/L and ≤70.0 g/L;
phosphoric acid present in an amount of ≥210.0 ml/L and ≤230.0 ml/L; and
sulfuric acid present in an amount of ≥560.0 ml/L and ≤580.0 ml/L,
wherein the total volume of the colloidal solution is 1.0 litre (L).

11. The method of claim 8, wherein the surface treated polymeric article has:
a Notched Izod Impact strength of ≥15.0 kJ/m² and ≤50.0 kJ/m² when measured in accordance with ISO 180/1A; or
wherein the surface treated polymeric article has a water contact angle of ≥60.0° and ≤85.0° as determined in accordance with ASTM D5946-17.

12. A metal plated article comprising:
a metal layer; and
a polymeric substrate layer comprising a surface treated polymeric article; comprising:
a thermoplastic polymer composition, wherein the thermoplastic polymer composition comprises:
a copolymer (A) present in an amount of ≥35.0 wt. % and ≤70.0 wt. %, with regard to the total weight of the thermoplastic polymer composition, wherein the copolymer (A) comprises polymeric units derived from (i) a vinyl aromatic monomer, and (ii) a vinyl nitrile monomer;
a rubber modified thermoplastic polymer (E) present in an amount of ≥26.0 wt. % and ≤50.0 wt. % with regard to the total weight of the thermoplastic polymer composition; and
a functionalized polymer (FP), present in an amount of ≥1.0 wt. % and ≤15.0 wt. %, with regard to the total weight of the thermoplastic polymer composition, wherein the functionalized polymer (FP) is styrene maleic anhydride (SMA) copolymer or maleic anhydride grafted polystyrene (MA-g-PS);
wherein the metal layer is disposed on at least a portion of the polymeric substrate layer.

13. The metal plated article of claim 12, wherein the metal layer is adhered to the treated surface of the polymeric substrate layer at a peel strength of ≥0.14 N/mm as determined in accordance with ASTM B 533-85 (2004).

14. The metal plated article of claim 12 comprising
a metal plated precursor article comprising the surface treated polymeric article subjected to chemical plating.

15. (canceled)

16. The metal plated article of claim 12, wherein the surface treated polymeric article is contacted with a chemical reagent for a time period between ≥5.0 minutes and ≤30.0 minutes.

17. The metal plated article of claim 14, wherein the metal plated precursor article is contacted with a metal electrolyte solution at an applied electric current of ≥1.0 Amps and ≤4.0 Amps.

18. The metal plated article of claim 17, wherein the metal plated precursor article is contacted with the metal electrolyte solution for a time period of ≥5 minutes and ≤35 minutes.

19. The metal plated article of claim 12, wherein the surface treated polymeric article further comprises an additive mixture present in an amount of ≥0.0 wt. % and ≤5.0 wt. %, with regard to the total weight of the thermoplastic polymer composition.

20. The metal plated article of claim 12, wherein the vinyl aromatic monomer is selected from the group consisting of styrene, α-methyl styrene, dibromostyrene, vinyltoluene, vinylxylene, butylstyrene, and p-hydroxystyrene, methoxystyrene, preferably the vinyl aromatic monomer is styrene.

21. The metal plated article of claim 12, wherein the vinyl nitrile monomer is selected from the group consisting of acrylonitrile, alpha-chloro acrylonitrile, methacrylonitrile, and ethacrylonitrile.
